(19) United States
(12) Patent Application Publication
(10) Pub. No.: US 2007/0116960 A1
(43) Pub. Date: May 24, 2007

(54) Aviation coating compositions and the use thereof

(76) Inventor: Gary W. Nickel, Sewell, NJ (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/438,517

(22) Filed: May 22, 2006

Related U.S. Application Data
(60) Provisional application No. 60/692,995, filed on Jun. 22, 2005.

(51) Int. Cl. B32B 27/00; C08L 63/00; C08L 71/00; B32B 33/00

(52) U.S. Cl. 428/413; 525/523; 525/528

(57) ABSTRACT

The present invention is directed to a coating composition that produces a high quality gloss dried film coating on a substrate that is resistant to aircraft hydraulic fluids. This invention is also directed to a method of producing said coating composition and the use thereof. This invention is further directed to the use of the coating composition and the process in aviation coating applications.

### CROSS-REFERENCE TO RELATED APPLICATION

This application claims priority under 35 U.S.C. §119 from U.S. Provisional Application Ser. No. 60/692,995, filed Jun. 22, 2005.

### FIELD OF INVENTION

The present invention is directed to a coating composition that produces a high quality gloss film coating that is resistant to aircraft hydraulic fluids. This invention is also directed to a method of producing said coating composition and the use thereof. This invention is further directed to the use of the coating composition and the process in aviation coating applications.

### BACKGROUND OF INVENTION

Aluminum and its alloys are commonly used in many industrial and consumer applications due to their light weight and high strength properties. Aircraft airframes and outer skins are among the more demanding applications for metals such as aluminum and its alloys. In order to prevent or minimize corrosion and to provide decorative and appealing appearance of an aircraft, the airframe and outer skin are usually provided with a protective coating that is usually applied in one or more layers. In the case of multi-layer coatings, the first or primer layer, that is tenaciously adherent to the metal such as aluminum or its alloys, typically includes an organic polymer within which is dispersed chromate corrosion-inhibiting compounds. Non-chromate corrosion-inhibiting compounds may also be used in such primer layer. Other layer(s) are then applied over the primer layer. These layer(s) may also be polymer-based and may include colored pigments to produce decorative and appearance effects, such as the airline colors and gloss appearance. In certain instances, a unilayer coating (“unicoat”) is applied which contains the corrosion inhibiting compound and any optional coloring pigments.

In addition to corrosion protection, a coating for a jet aircraft needs to be resistant to the degradation and attack by solvents, such as phosphate ester-based aircraft hydraulic fluid, commonly used in the aviation industry.

In order to apply coatings in an environmentally safe manner, coating compositions with low VOC (volatile organic component) are preferred to reduce the release of organic solvents to atmosphere during coating process.

The freshly applied paint needs to be dried and cured to prevent the wet paint from collecting dirt in the air or other contaminants. Typically, the paint is dried and cured under specific conditions, such as under UV radiation or with a heating source to elevate temperature. For aircraft coating, it is economically undesirable to establish and maintain such specific drying and curing conditions for a space large enough to accommodate an entire aircraft. For increasing productivity, it is also desired to reduce drying and curing time. It is therefore in need to have a coating composition that can be dried and cured rapidly and under ambient temperature while still providing solvent resistance, decorative appearance such as high gloss and outstanding performance characteristics particularly mar-resistance and resistance to environmental etching.

One of the approaches used in addressing the foregoing involves utilizing a binder containing a linear or branched cycloaliphatic moiety-containing oligomer. However, these coating compositions disclosed in PCT Application U.S. 97/08179, cure at significantly high cure temperatures, in the range of from 120° C. to 150° C. Coating compositions disclosed in a commonly owned U.S. Pat. No. 6,221,494 are curable under ambient conditions, however, are not resistant to phosphate ester-based aircraft hydraulic fluid. Thus, a continuing need still exists for a low VOC coating composition that cures under ambient conditions and is resistant to phosphate ester-based aircraft hydraulic fluid, such as SKYDROL (registered trademark of Solutia, Inc.), used in the civil aviation industry, and its military equivalent.

### SUMMARY OF INVENTION

The present invention is directed to a coating composition comprising a binder, which comprises:
(a) A hydroxyl component comprising a linear or branched cycloaliphatic moiety-containing reactive oligomer having a GPC weight average molecular weight in a range from about 300 to about 3000 and a polydispersity in a range from about 1.01 to about 1.7, said reactive oligomer having in a range of from about 2 to about 10 hydroxyl groups, at least one of said hydroxyl groups on average being a primary hydroxyl group, said oligomer being produced by contacting an oligomeric acid with a monofunctional epoxy selected from the group consisting of ethylene oxide, butylene oxide, propylene oxide, glycidyl ester of neodecanoic acid, and a combination thereof; and
(b) a crosslinking component comprising an oligomeric crosslinker provided with at least two isocyanate groups wherein the ratio of equivalents of isocyanate per equivalent of hydroxyl groups is in the range of from 1.2/1 to 3.0/1;

Wherein a layer of the coating composition on a substrate surface upon cure produces a coating resistant to phosphate ester-based aircraft hydraulic fluids.

The present invention is also directed to a process for producing a coating that is resistant to phosphate ester-based aircraft hydraulic fluids on the surface of a substrate, said process comprising:
(a) mixing hydroxyl and crosslinking components of a binder of a coating composition to form a pot mix, wherein said hydroxyl component comprises a linear or branched cycloaliphatic moiety-containing reactive oligomer having a GPC weight average molecular weight in a range from about 300 to about 3000 and a polydispersity in a range from about 1.01 to about 1.7, said reactive oligomer having in a range of from about 2 to about 10 hydroxyl groups, at least one of said hydroxyl groups on average being a primary hydroxyl group, said oligomer being produced by contacting an oligomeric acid with a monofunctional epoxy selected from the group consisting of ethylene oxide, butylene oxide, propylene oxide, glycidyl ester of neodecanoic acid, and a combination thereof, and wherein said crosslinking component comprising an oligomeric crosslinker provided with at least two isocyanate groups wherein the ratio of equivalents of isocyanate per equivalent of hydroxyl groups is in the range of from 1.2/1 to 3.0/1;
(b) applying a layer of said pot mix on said surface; and
(c) curing said layer under ambient conditions to form said coating on the surface of said substrate.

### DETAILED DESCRIPTION OF PREFERRED EMBODIMENT

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

“Two-pack coating composition” means a thermoset coating composition comprising two components that are stored in separate containers, which are typically sealed for increasing the shelf life of the components of the coating composition. The components are mixed just prior to use to form a pot mix, which has a limited pot life, typically few minutes, such as 15 minutes to 45 minutes to few hours, such as 4 hours to 10 hours. The pot mix is applied as a layer of desired thickness on a substrate surface, such as an aircraft frame. After application, the layer dries and cures to form a coating on the substrate surface having desired coating properties, such as, high gloss, mar-resistance, resistance to environmental etching and resistance to degradation by solvent.

“Low VOC coating composition” means a coating composition that includes less than 0.6 kilograms of organic solvent (volatile organic component) per liter (5 pounds per gallon), preferably less than 0.53 kilograms (4.4 pounds per gallon) of the composition. VOC level is determined under the procedure provided in ASTM D3960.

“High solids composition” means a coating composition having solid component of above 40 percent, preferably in the range of from 45 to 85 percent and more preferably in the range of from 50 to 65 percent, all in weight percentages based on the total weight of the composition.

“GPC weight average molecular weight” means a weight average molecular weight measured by utilizing gel permeation chromatography. A high performance liquid chromatograph (HPLC) supplied by Hewlett-Packard, Palo Alto, Calif. was used. Unless stated otherwise, the liquid phase used was tetrahydrofuran and the standard was polymethyl methacrylate.

“Polydispersity” means GPC weight average molecular weight divided by GPC number average molecular weight.

“(Meth)acrylate” means acrylate and methacrylate.

“Tg” means glass transition temperature.

“Polymer particle size” means the diameter of the polymer particles measured by using a Brookhaven Model BI-90 Particle Sizer supplied by Brookhaven Instruments Corporation, Holtsville, N.Y., which employs a quasi-elastic light scattering technique to measure the size of the polymer particles. The intensity of the scattering is a function of particle size. The diameter based on an intensity weighted average is used. This technique is described in Chapter 3, pages 48-61, entitled Uses and Abuses of Photon Correlation Spectroscopy in Particle Sizing by Weiner et al. in 1987 edition of American Chemical Society Symposium series.

“Polymer solids” or “Binder solids” means a polymer or binder in its dry state.

“Aircraft” in this specification refers to both fixed wing and non-fixed wing devices for traveling in air, such as propeller driven airplanes, jet driven air planes and helicopters. Examples of aluminum alloys used in aircraft are the 2XXX, 6XXX and 7XXX series, such as 2024T3 or 7075T6 or the like. These aluminum alloys are often treated with surface treatment such as Surface Alodine®, trademark of American Chemical Paint Company Corporation, Del. Ambler, Pa., treatment before other coating layers are applied.

“Jet engine device” in this specification is directed to a jet engine and/or any device with a jet engine attached, wherein the device may travel in air, water or on land, such as a jet driven watercraft such as a jet driven speed boat, a jet aircraft, or a jet driven landcraft such as a jet driven high speed vehicle.

The present invention is directed to a two-pack low VOC ambient curable coating composition that is particularly suited for use in coating on jet driven traveling devices, especially for use in aircrafts and other aviation coating processes. The composition includes a binder in an organic solvent. The amount of organic solvent used results in the composition having VOC of less than 0.6 kilograms (5 pounds per gallon) and preferably in the range of 0.25 kilograms to 0.53 kilograms (2.1 pounds to 4.4 pounds per gallon) of organic solvent per liter of the composition.

The binder includes a hydroxyl and a crosslinking component. The hydroxyl component includes in the range of from 2 weight percent to 100 weight percent, preferably in the range of from 10 weight percent to 90 weight percent, more preferably in the range of from 20 weight percent to 80 weight percent and most preferably in the range of from 30 weight percent to 50 weight percent of a linear or branched cycloaliphatic moiety-containing reactive oligomer or a blend of such oligomers. The reactive oligomer is provided with a GPC weight average molecular weight not exceeding about 3000, preferably in the range of from 300 to 2000, more preferably in the range of from 500 to 1200. When the molecular weight of the reactive oligomer exceeds 3000, the reactive oligomer becomes too viscous. As a result, larger amount of solvent is needed to produce a coating composition that can be sprayed by conventional spray coating devices. However, such a coating composition will not be a low VOC coating composition. The polydispersity of the reactive oligomer of the present invention does not exceed about 1.7. Preferably, the polydispersity is in the range of from 1.01 to 1.5, more preferably in the range of from 1.01 to 1.3. If the polydispersity of the reactive oligomer exceeds 1.7, a coating composition which includes such a reactive oligomer will produce coating compositions too viscous for conventional spray coating devices and such compositions will have poor pot life.

The reactive oligomer is provided on an average in the range of from 2 to 10, preferably in the range of from 2 to 6 and more preferably in the range of from 2 to 4 with hydroxyl groups. Of these hydroxyl groups, on an average at least one, preferably in the range of 1 to 4, must be primary hydroxyl groups. The foregoing average range may be attained by blending reactive oligomers having various number of primary hydroxyl groups. The primary hydroxyl group is a hydroxyl group positioned at the terminal end of the reactive oligomer. It is believed that the reactive oligomers of the present invention derive their a high degree of reactivity from (a) the primary hydroxyl groups as opposed to the more common secondary hydroxyls, (b) the narrow polydispersity, and (c) by ensuring that hydroxyl functionalities are uniformly distributed on each oligomeric chain of the reactive oligomer.

The reactive oligomer of the present invention is produced by a process detailed in a commonly owned U.S. Pat. No. 6,221,494, which is incorporated herein by reference. Briefly, the oligomer is produced by first reacting a multifunctional alcohol, such as, pentaerythritol, hexandiol, trimethylol propane with alicyclic monomeric anhydrides, for example, hexahydrophthalic anhydride or methylhexahydrophthalic anhydride to produce an oligomeric acid. Mixtures of the foregoing anhydrides may also be used. Non-alicyclic anhydrides (linear or aromatic), for example, succinic anhydride or phthalic anhydride could also be added to the alicyclic monomeric anhydrides. Oligomeric acids having at least one hydroxyl functionality are also suitable, prepared by reacting the multifunctional alcohol with less than a stoichiometric amount of the monomeric anhydride.

The oligomeric acid is then reacted with a monofunctional epoxy, at a reaction gage pressure of less than 14 kg/cm 2 (200 psig), preferably at the reaction gage pressure in the range of from 0 kg/cm 2 to 2.1 kg/cm 2 (0 to 30 psig) to produce the reactive oligomer. The oligomerization is generally carried out at a reaction temperature in the range of from 60° C. to 200° C., preferably in the range of from 80° C. to 170° C., and more preferably in the range of from 900° C. to 1500° C. Typical reaction time is in the range of from 1 hours to 24 hours, preferably 1 hour to 4 hours.

The foregoing two-step process ensures that the hydroxyl functionalities are uniformly distributed on each oligomeric chain of the reactive oligomer and the reactive oligomers are provided with the polydispersity in the range described earlier.

The monofunctional epoxy suitable for use in the present invention include alkylene oxide of 2 to 12 carbon atoms, ethylene, propylene and butylene oxides are preferred, ethylene oxide is more preferred. Other epoxies, such as, glycidyl ester of neodecanoic acid (also known as 2,3-epoxypropyl neodecanoate) sold as Cardura® E-10 glycidyl ester, supplied by Exxon Chemicals, Houston, Tex., under the respective trademark, may be used as a sole epoxy or in conjunction with the other epoxies described above.

It should be understood that in generating the primary hydroxyl functionalities the foregoing reaction results in a blend of primary hydroxyl functionalities, such that the reactive oligomers are provided with varying number of primary hydroxyl functionalities, i.e., some of the oligomers may have more or less primary hydroxyl functionalities. So long as the average number of primary hydroxyl functionalities on the reactive oligomer fall with in the range described earlier, the inclusion of the reactive oligomer of the present invention in a coating composition results in a low VOC high solids coating composition that cures under ambient conditions.

The hydroxyl component of the binder of the present invention may be blended with non-alicyclic (linear or aromatic) oligomers, if desired. Such non-alicyclic-oligomers may be made by the aforedescribed process by using non-alicyclic anhydrides, such as succinic or phthalic anhydrides, or mixtures thereof. Caprolactone oligomers described in the U.S. Pat. No. 5,286,782 may also be used.

The hydroxyl component of the binder of the present invention may further include in the range of from 0.1 percent to 95 percent, preferably in the range of from 10 percent to 90 percent, more preferably in the range of from 20 percent to 80 percent and most preferably in the range of from 50 percent to 70 percent, all based on the total weight of the hydroxyl component of an acrylic polymer, a polyester or a combination thereof. It is believed that by adding one or more the foregoing polymers to the hydroxyl component, the two-pack coating composition resulting therefrom provides coating with improved appearance, sag resistance, and flow and leveling properties.

The acrylic polymer has a GPC weight average molecular weight exceeding 3000, preferably in the range of from 3000 to 20,000, more preferably in the range of 6000 to 20,000, and most preferably in the range of from 8000 to 12,000. The Tg of the acrylic polymer varies in the range of from 0° C. to 100° C., preferably in the range of from 100° C. to 800° C.

The acrylic polymer suitable for use in the present invention may be any conventional solvent soluble acrylic polymer conventionally polymerized from typical monomers, such as alkyl (meth)acrylates or alkyl-substituted cycloaliphatic acrylate having alkyl carbon atoms in the range of from 1 to 18, preferably in the range of from 1 to 12, such as trimethylcyclohexyl methacrylate, t-butyl cyclohexyl methacrylate, isobornyl methacrylate, or combinations thereof, and styrene such as t-butyl styrene, and functional monomers, such as, hydroxy ethyl acrylate and hydroxy ethyl methacrylate.

In addition to the forgoing polymers, the hydroxyl component of the binder of the present invention may further contain up to 40 percent, preferably in the range of from 5 to 35, more preferably in the range of from 20 to 30, all in weight percent based on the total weight of the binder of a dispersed acrylic polymer which is a polymer particle dispersed in an organic media, wherein the polymer particle is emulsion stabilized by what is known as steric stabilization. Preferably, the polymer particle is provided with a core having macromonomer chains or arms attached to it. The preferred average particle size of the core is in the range of from 0.1 to 0.5 microns, preferably in the range of from 0.15 to 0.4, more preferably in the range of from 0.15 to 0.35.

The dispersed acrylic polymer includes in the range of from about 10 percent to 90 percent, preferably in the range of from 50 percent to 80 percent all in weight percent based on the weight of the dispersed polymer, of a core formed from high molecular weight polymer having a weight average molecular weight of about 50,000 to 500,000, preferably in the range of from 50,000 to 200,000, more preferably in the range of from 50,000 to 150,000. The arms make up about 10 percent to 90 percent, preferably 10 percent to 59 percent, all in weight percent based on the weight of the dispersed polymer. The arms are formed from a low molecular weight polymer having weight average molecular weight of in the range of from about 1,000 to 30,000, preferably in the range of from 3000 to 20, 000, more preferably in the range of from 3000 to 15,000.

The core of the dispersed acrylic polymer is comprised of polymerized acrylic monomer(s) optionally copolymerized with ethylenically unsaturated monomer(s). Suitable monomers include styrene, alkyl (meth)acrylate having alkyl carbon atoms in the range of from 1 to 18, preferably in the range of from 1 to 12; ethylenically unsaturated monocarboxylic acid, such as, (meth)acrylic acid, and silane-containing monomers. Other optional monomers include hydroxyalkyl (meth)acrylate or acrylonitrile. Optionally, the core may be crosslinked through the use of diacrylates or dimethacrylates, such as, allyl methacrylate or through post reaction of hydroxyl moieties with polyfunctional isocyanates.

The macromonomer arms attached to the core may be polymerized from monomers, such as alkyl (meth)acrylates having 1 to 12 carbon atoms. Typical hydroxy-containing monomers are hydroxy alkyl(meth)acrylates, described above.

The polyester has a GPC weight average molecular weight exceeding 1500, preferably in the range of from 1500 to 100,000, more preferably in the range of 2000 to 50,000, still more preferably in the range of 2000 to 8000 and most preferably in the range of from 2000 to 5000. The Tg of the polyester varies in the range of from −50° C. to +100° C., preferably in the range of from −20° C. to +50° C.

The polyester suitable for use in the present invention may be any conventional solvent soluble polyester conventionally polymerized from suitable polyacids, including cycloaliphatic polycarboxylic acids, and suitable polyols, which include polyhydric alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic acid and cyclobutanetetracarboxylic acid. The cycloaliphatic polycarboxylic acids can be used not only in their cis but also in their trans form and as a mixture of both forms. Examples of suitable polycarboxylic acids, which, if desired, can be used together with the cycloaliphatic polycarboxylic acids, are aromatic and aliphatic polycarboxylic acids, such as, for example, phthalic acid, isophthalic acid, terephthalic acid, halogenophthalic acids, such as, tetrachloro-or tetrabromophthalic acid, adipic acid, glutaric acid, azelaic acid, sebacic acid, fumaric acid, maleic acid, trimellitic acid, and pyromellitic acid.

Suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, tris(hydroxyethyl) isocyanate, polyethylene glycol and polypropylene glycol. If desired, monohydric alcohols, such as, for example, butanol, octanol, lauryl alcohol, ethoxylated or propoxylated phenols may also be included along with polyhydric alcohols. The details of polyester suitable for use in the present invention are further provided in the U.S. Pat. No. 5,326,820, which is incorporated herein by reference. One of the commercially available polyester, which is particularly preferred, is SCD®-1040 polyester, which is supplied by Etna Product Inc., Chagrin Falls, Ohio.

In the absence of the aforedescribed acrylic polymer or polyester in the hydroxyl component or when low levels of less than 20 weight percent of the aforedescribed acrylic polymer or polyester is present in the hydroxyl component, the reactive oligomers having three or more hydroxyl functionalities are most preferred. At higher levels of the aforedescribed acrylic polymer or polyester in the hydroxyl component, the need for the reactive oligomers having three or more hydroxyl functionalities is not as important to get good film properties. In the later coating systems, the reactive oligomers having two hydroxyl functionalities can be employed to good advantage.

The crosslinking component of the binder is stored separately from the hydroxyl component prior to application. The crosslinking component includes an oligomeric crosslinker or a blend thereof. The crosslinker is provided with at least two isocyanate groups (—NCO groups), such that the ratio of equivalents of isocyanate of the oligomeric crosslinker per equivalent of the hydroxyl (—OH group) of the hydroxyl component, hereafter referred to as “NCO/OH ratio”, is in the range of from 0.5/1 to 3.0/1 as disclosed in a commonly owned U.S. Pat. No. 6,221,494. A coating with NCO/OH ratio in the range of from 0.5/1 to 1.1/1 is, however, not sufficiently resistant to solvents such as phosphate ester-based aircraft hydraulic fluid and therefore unsuitable for the use in jet engine aircrafts. Although it is known in the art that higher NCO/OH ratio may improve solvent resistance, it is also known that high ratio causes undesired side effects such as slow dry and initial softness during curing. Applicant of this invention unexpectedly discovered that a combination of a narrower range of the NCO/OH ratio and the selection of preferred NCO containing isocyanates produces a coating composition with desired solvent resistance and coating appearance. The NCO/OH ratio of this invention is in the range of from 1.2/1 to 3.0/1, preferably in the range of from 1.5/1 to 3/1, more preferably in the range of from 1.5/1 to 2.5/1. Some of suitable oligomeric crosslinkers for aviation coating include aliphatic, or cycloaliphatic isocyanates, trifunctional isocyanates and isocyanate functional adducts of a polyol and difunctional isocyanates. Some of the particular isocyanates include diisocyanates such as 1,6-hexamethylene diisocyanate, isophorone diisocyanate, biscyclohexyl diisocyanate, ethyl ethylene diisocyanate, 1-methyltrimethylene diisocyanate, and bis-(4-isocyanatocyclohexyl)-methane. For a non-primer layer(s), such as topcoats, non-aromatic isocyanates as described above are preferred. For use in primer layers of a coating, aromatic isocyanates, such as 4,4′-biphenylene diisocyanate, toluene diisocyanate, tetramethylene xylene diisocyanate, 1,3-phenylene diisocyanate, 1,5-napthalene diisocyanate, and 4,4′-diisocyanatodiphenyl ether, may also be used.

Some of the suitable trifunctional isocyanates include triphenylmethane triisocyanate, 1,3,5-benzene triisocyanate, and 2,4,6-toluene triisocyanate. Trimers of diisocyanate, such as the trimer of hexamethylene diisocyanate sold under the trademark Desmodur®N-3390 by Bayer Corporation of Pittsburgh, Pa. and the trimer of isophorone diisocyanate are also suitable. Furthermore, trifunctional adducts of triols and diisocyanates are also suitable. Trimers of diisocyanates are preferred and trimers of isophorone and hexamethylene diisocyanates are more preferred. Low viscosity trimers of diisocyanate, such as the one sold under the trademark Desmodur® XP 2410 by Bayer Corporation of Pittsburgh, Pa. are further more preferred. Viscosity of the trimers of diisocyanate is preferably below 1500 mPa·s, more preferably below 1000 mPa·s, and further more preferably at or below 700 mPa·s. Viscosity measurement is based on ASTM test D2196.

The hydroxyl component of the binder may include a catalytic amount of a catalyst for accelerating the curing process. The catalytic amount depends upon the reactivity of the primary hydroxyl group of the reactive oligomer present in the hydroxyl component of the binder. Generally, in the range of from about 0.001 percent to about 5 percent, preferably in the range of from 0.01 percent to 2 percent, more preferably in the range of from 0.02 percent to 1 percent, all in weight percent based on the total weight of binder solids of the catalyst is utilized. A wide variety of catalysts can be used, such as, tin compounds, including dibutyl tin dilaurate; tertiary amines, such as, triethylenediamine. These catalysts can be used alone or in conjunction with carboxylic acids, such as, acetic acid. One of the commercially available catalyst sold under the trademark, Fascat® 4202 dibutyl tin dilaurate by Elf-Atochem North America, Inc. Philadelphia, Pa., which is particularly suitable.

The hydroxyl or crosslinking component of the binder of the coating composition of the present invention, which is formulated into high solids coating systems further contains at least one organic solvent which is typically selected from the group consisting of aromatic hydrocarbons, such as, petroleum naphtha or xylenes; ketones, such as, methyl amyl ketone, methyl isobutyl ketone, methyl ethyl ketone or acetone; esters, such as, butyl acetate or hexyl acetate; and glycol ether esters, such as propylene glycol monomethyl ether acetate. The amount of organic solvent added depends upon the desired solids level as well as the desired amount of VOC of the composition. If desired, the organic solvent may be added to both components of the binder.

The coating composition of the present invention may also contain conventional, well known in the art, additives, such as pigments, stabilizers, rheology control agents, flow agents, toughening agents, UV protection agents, moisture scavenger and fillers. Such additional additives will, of course, depend on the intended use of the coating composition. Fillers, pigments, and other additives that would adversely effect the clarity of the cured coating will not be included if the composition is intended as a clear coating. The foregoing additives may be added to either the hydroxyl or crosslinking components, or both, depending upon the intended use of the coating composition. These additives are preferably added to the hydroxyl component.

The hydroxyl and crosslinking components are mixed just prior to use or about 5 to 30 minutes before use to form a pot mix, which has limited pot life. A layer of the pot mix is typically applied to a substrate by conventional techniques, such as, spraying, electrostatic spraying, roller coating, dipping or brushing. The layer of the coating composition then cures under ambient conditions in the range of 30 minutes to 24 hours to form a coating on the substrate having the desired coating properties. It is understood that the actual curing time depends upon the thickness of the applied layer and on any additional mechanical aids, such as, fans that assist in continuously flowing air over the coated substrate to accelerate the cure rate. If desired, the cure rate may be further accelerated by baking the coated substrate at temperatures generally in the range of from about 30° C. to 50° C. for a period of from about 1 to 24 hours. [49] If desired, the APHA color values of the coating composition, when used as a clear coating composition, may be lowered in the range of 0 to 80, preferably in the range of from 0 to 50 by adding, in the range of from 0.1 weight percent to 3 weight percent, preferably in the range of from 0.4 weight percent to 1 weight percent all in percentages based on reactive oligomer solids, a phosphite compound to the coating composition. Some of the suitable phosphite compounds include 9,10-dihdydro-9-oxa-10-phosphaphenanthrene and triphenyl phosphite, of which 9,10-dihdydro-9-oxa-10-phosphaphenanthrene is preferred.

The present formulations are particularly useful as a clear coating for outdoor articles, such as the frames of an aircraft and other jet engine devices. The substrate is generally prepared with surface treatment such as Surface Alodine® treatment, a primer and or a color coat or other surface preparation prior to coating with the present compositions. It is within the knowledge of a person skilled in the art that a pigment or a mixture of pigments can be added to the formulation to form a colored topcoat. The pigment can be added to either the hydroxyl or the crosslinking component. It is preferred that the pigment is added to the hydroxyl component. The colored topcoat may be applied on an Alodine® treated surface, on top of a primer layer, or another colored coat layer.

### Test Procedures

The following test procedures were used for generating data reported in the examples below.

Resistance to solvent degradation and attack is measured by a standard SKYDROL resistance test. Briefly, the SKYDROL test includes first immersing a coated test panel in SKYDROL fluid (or its military equivalent when the coating is for a military aircraft) for 14 to 30 days. The test panel is then wiped dry and inspected for blistering, loss of coating adhesion or other deterioration. A pencil hardness test is conducted to measure the hardness of the coating. In this test, a squared-off nib of an “HB” hardness pencil is held at a 45 degree angle to the panel and is pushed along the coating for at least 1/4 inch with sufficient applied force to cause a scratch or crumble the lead nib. If the nib crumbles without scratching the coating, harder pencil numbers are used sequentially until a scratch is visible. The hardness number of this pencil is the “pencil hardness number” of the coating. A hardness scale is shown here from hard (4H or harder) to soft (4B or softer):
4H>2H>H>F>HB>B>2B>3B>4B.

A coating with a pencil hardness number greater than 2B after a 30 day test is generally considered SKYDROL resistant. Details for Standard Test Method for Film Hardness by Pencil Test are available from ASTM D3363-05 or D3363-00.

Gardner-Holdt Viscosity was measured under ASTM test D1545.

The Zahn 2 viscosity in seconds was measured using the Zahn 2 cup.

The dry time of a coated layer of the composition was measured as BK3 surface dry time under ASTM D5895.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

Procedure 1: Preparation of Acrylic Copolymer Component

This procedure illustrates the preparation of a copolymer derived from comonomers comprising a branched cycloaliphatic (meth)acrylic monomer. In a reactor equipped with stirrer, condenser, thermometer and feed vessel, 19.2 parts of methylamylketone are added and heated to reflux. A blend of 10.3 parts styrene, 12.3 parts 2-ethylhexylacrylate, 9.9 parts isobornylmethacrylate, 26.0 parts hydroxypropylmethacrylate, and 9.9 parts isobutylmethacrylate is fed to the reactor over 6 hours. A blend of 2.2 parts t-butylperoxy acetate and 7.1 parts methylamylketone is added to the reactor simultaneously with the first blend over 6.25 hours. Mn refers to number average molecular weight while Mw refers to weight average molecular weight. The test results were as follows:

| Parameter | Value |
|---|---|
| Solids | 71.4 |
| Viscosity | V |
| Mn | 3100 |
| Mw | 5500 |
| Composition (wt): | 15/18/14.5/38/14.5 |
| Styrene/2-ethylhexylacrylate/Isobornylmethacrylate/ | |
| Hydroxypropylmethacrylate/isobutylmethacrylate | |
| Calculated Tg | 16° C. |
| OH # theoretical | 164 |
| Wt % of OH on solids | 4.97% |

Procedure 2: Preparation of Tetra-Hydroxy Functional Oligomer

This procedure illustrates the preparation of a hydroxy-functional oligomer for use in the claimed composition and is modified from procedure 1 of U.S. Pat. No. 5,753,756, which is incorporated herein by reference. Briefly, 160.16 g of butylacetate, 136 g of monopentaerythritol, and 504 g of methylhexahydrophthalic anhydride are loaded in a glass reactor and heated to reflux until dissolved. Afterwards, 750 g of CE10 (Cardura™ E10-glycidyl ester of versatic acid from Exxon Chemicals, Houston, Tex., under the respective trademark) are added, followed by 1.39 g of dibutyl tin dilaurate dissolved in 8.61 g of butylacetate. The mixture is further refluxed until the acid value (AV) or acid number (AN), used hereafter as synonymous terms, is below 3. A further 177.33 g of butylacetate are added. The total reaction time is about 3 hours. Exemplary test results were as follows. The hydroxy numbers or values are calculated from the theoretical structure. Polydispersity=1.22.

| Parameter | Value |
|---|---|
| Solids | 80.5% |
| Viscosity | X |
| AN | 2.8 |
| Mn | 1190 |
| Mw | 1460 |
| Molar ratio: | 1/3/3 |
| Monopentaerythritol/methylhexahydrophthalic | |
| anhydride/Cardura ™ E10 | |
| OH # theoretical | 161 |
| Wt % of OH on resin solids | 5.06% |

Procedure 3: Preparation of Tri-Hydroxy Functional Oligomer

The following ingredients in grams are charged to a vessel rated for high pressure and heated to 145° C.

| | |
|---|---|
| Methylamyl ketone | 133 |
| Trimethylolpropane | 134 |
| Triethylamine | 0.23 |

To the vessel, 483.84 grams of Milldride® methyl hexahydrophthalic anhydride supplied by Milliken Chemical Company, Spartanburg, S.C. under the respective trademark is then added over one hour. The batch is then held at 145° C. for 6 hours. The batch is subsequently cooled to 25° C., the pressure vessel is sealed and 195.3 g of ethylene oxide, supplied by M. G. Industries, Malvern, Pa., is added and the batch is heated to 110° C. and held at 110° C. for 6 hours. Excess ethylene oxide is removed by purging the batch with nitrogen. The acid number on solids is tested at less than 10 mg KOH/gram. The resulting reactive oligomer at 85 percent solids has all primary hydroxyl functionalities. The Gardner-Holdt viscosity of the resulting oligomer was Z2. Wt % of OH on solids was 6.73%.

### Example 1

### Coating Composition

A clearcoat composition is prepared according to the following formulation.

| Binder Component | |
|---|---|
| Acrylic Polymer (Procedure 1) | 12.60 |
| Tetra-Hydroxy Oligomer (Procedure 2) | 4.67 |
| Tri-Hydroxy Oligomer (Procedure 3) | 5.33 |
| Ethyl acetate | 7.20 |
| Butyl acetate | 7.02 |
| 1-chloro-4(trifluoromethyl)benzene | 1.80 |
| Additives (flow, UV-protection, moisture scavenger, catalysts) | 1.70 |
| Crosslinking Component | |
| Bayer Desmodur XP2410 Isocyanate Trimer | 18.91 |
| Organic solvents common to the art | 6.30 |
| Potlife Extender | |
| 2,4-pentanedione | 1.00 |
| Organic solvents common to the art | 4.00 |
| Exempt Reducer | |
| VOC exempt organic solvents | 5.00 |

* The coating composition of this example has NCO/OH molar ratio of 1.95/1.

### Example 2

### Measurement of Coating Property

White pigments Ti-Pure®R-960 Titanium Dioxide White from Dupont Titanium Technologies, Wilmington, Del., was added to the clearcoat composition of Example 1 to form a white topcoat. The topcoat was applied to an aluminum test panel according to conventional paint application procedure.

Viscosity was measured using the Zahn2 cup. Solvent resistance was measured in 2 steps: initial pencil hardness was tested after the coating was dried for at least 24 hours; the pencil hardness was measured again after the testing panel was soaked in SKYDROL 500 B-4 phosphate ester hydraulic fluid from Solutia, Inc., Delaware, for 30 days. Gloss and haze readings of the dried film were measured using Byk Gardner Haze-Gloss Glossmeter, from Byk Gardner USA, Columbia, Md. Wavescan was performed using Wave-Scan Plus also from Byk Gardner USA. Coating defects were measured by visual examination. No detectable defects were identified.

| Tests | Results |
|---|---|
| Viscosity | |
| Viscosity Initial Zahn 2 | 17 seconds |
| Viscosity 4 hour Zahn 2 | 19 seconds |
| Solvent Resistance | |
| Initial Pencil Hardness | 4H |
| Pencil Hardness after 30 day in Skydrol | 2H |
| Gloss Measurement | |
| 20 degree gloss | 86 |
| 60 degree gloss | 94 |
| Haze Measurement | |
| Byk-Gardner Haze | 17 |
| Wavescan Measurement | |
| Wavescan-Long | 1 |
| Short | 7 |
| R-value | 10 |
| Coating Defect Measurement | |
| Popping Defects | Not detectable |
| Crater Defects | Not detectable |
| Sandscratch Swelling | Not detectable |

* Skydrol is a registered trademark of Solutia, Inc.

What is claimed is:

1. A coating composition comprising a binder, which comprises:
(a) A hydroxyl component comprising a linear or branched cycloaliphatic moiety-containing reactive oligomer having a GPC weight average molecular weight in a range from about 300 to about 3000 and a polydispersity in a range from about 1.01 to about 1.7, said reactive oligomer having in a range of from about 2 to about 10 hydroxyl groups, at least one of said hydroxyl groups on average being a primary hydroxyl group, said oligomer being produced by contacting an oligomeric acid with a monofunctional epoxy selected from the group consisting of ethylene oxide, butylene oxide, propylene oxide, glycidyl ester of neodecanoic acid, and a combination thereof; and
(b) a crosslinking component comprising an oligomeric crosslinker provided with at least two isocyanate groups wherein the ratio of equivalents of isocyanate per equivalent of hydroxyl groups is in the range of from 1.2/1 to 3.0/1;
Wherein a layer of the coating composition on a substrate surface upon cure produces a coating resistant to phosphate ester-based aircraft hydraulic fluids.

2. The composition of claim 1 wherein the ratio of equivalents of the isocyanate per equivalent of the hydroxyl groups is in the range of from 1.5/1 to 2.5/1.

3. The composition of claim 1 wherein the monofunctional epoxy is a glycidyl ester of neodecanoic acid.

4. The composition of claim 1 wherein the crosslinking component comprising trifunctional isocyanates having viscosity less than 1500 mPa·s.

5. The composition of claim 1 wherein the crosslinking component comprising trifunctional isocyanates having viscosity less than 1000 mPa·s.

6. The composition of claim 1 wherein said hydroxyl component further comprises in the range of from about 0.1 weight percent to about 95 weight percent based on the total weight of the hydroxyl component of an acrylic polymer, a polyester or a combination thereof.

7. The composition of claim 1 wherein said hydroxyl component further comprises in the range of from about 50 weight percent to about 95 weight percent based on the total weight of the hydroxyl component of an acrylic polymer, a polyester or a combination thereof.

8. The composition of claim 1 wherein said hydroxyl component further comprises from about 5 to about 40 weight percent of a dispersed acrylic polymer, the percentage being based on the total weight of the binder.

9. The composition of claim 1 further comprising a pigment.

10. An article coated with the coating composition of claim 1.

11. The article in claim 10 is an aircraft frame.

12. A process for producing a coating on the surface of a substrate, said coating being resistant to phosphate ester-based aircraft hydraulic fluids, said process comprising:
(a) mixing hydroxyl and crosslinking components of a binder of a coating composition to form a pot mix, wherein said hydroxyl component comprises a linear or branched cycloaliphatic moiety-containing reactive oligomer having a GPC weight average molecular weight in a range from about 300 to about 3000 and a polydispersity in a range from about 1.01 to about 1.7, said reactive oligomer having in a range of from about 2 to about 10 hydroxyl groups, at least one of said hydroxyl groups on average being a primary hydroxyl group, said oligomer being produced by contacting an oligomeric acid with a monofunctional epoxy selected from the group consisting of ethylene oxide, butylene oxide, propylene oxide, glycidyl ester of neodecanoic acid, and a combination thereof, and wherein said crosslinking component comprising an oligomeric crosslinker provided with at least two isocyanate groups wherein the ratio of equivalents of isocyanate per equivalent of hydroxyl groups is in the range of from 1.2/1 to 3.0/1;
(b) applying a layer of said pot mix on said surface; and
(c) curing said layer under ambient conditions to form said coating on the surface of said substrate.

13. The process of claim 12 wherein the ratio of equivalents of the isocyanate per equivalent of the hydroxyl groups is in the range of from 1.5/1 to 2.5/1.

14. The composition of claim 12 wherein the monofunctional epoxy is a glycidyl ester of neodecanoic acid.

15. The process of claim 12 wherein the crosslinking component comprising trifunctional isocyanates having viscosity less than 1500 mPa·s.

16. The process of claim 12 wherein the crosslinking component comprising trifunctional isocyanates having viscosity less than 1000 mPa·s.

17. The process of claim 12 wherein the coating composition further comprises a pigment.

18. The process of claim 12 wherein the substrate is an aircraft frame.

19. A substrate coated in accordance with the process of claim 12.
